(19) United States
(12) Patent Application Publication
(10) Pub. No.: US 2017/0100984 A1
(43) Pub. Date: Apr. 13, 2017

(54) ELECTRIC COMPRESSOR

(71) Applicant: KABUSHIKI KAISHA TOYOTA JIDOSHOKKI, Kariya-shi (JP)

(72) Inventors: Yusuke KINOSHITA, Kariya-shi (JP); Ken SUITOU, Kariya-shi (JP); Tatsuya KOIDE, Kariya-shi (JP); Junya YANO, Kariya-shi (JP)

(73) Assignee: KABUSHIKI KAISHA TOYOTA JIDOSHOKKI, Kariya-shi (JP)

(21) Appl. No.: 15/281,370

(22) Filed: Sep. 30, 2016

(30) Foreign Application Priority Data
Oct. 7, 2015 (JP) 2015-199406

(51) Int. Cl. B60H 1/00; H02K 7/00; H02K 1/14; H02K 3/18; F04C 18/02; H02P 27/06

(52) U.S. Cl. CPC B60H 1/00428; F04C 18/0215; H02P 27/06; H02K 1/14; H02K 3/18; H02K 7/003; F04C 2240/40; F04C 2210/26

(57) ABSTRACT

An electric compressor includes a housing accommodating a compression mechanism unit and an electric motor; an inverter; an inverter cover defining, in conjunction with the housing, an internal space accommodating the inverter; and a sealing member sealing the internal space. The inverter cover includes an outer cover portion formed of resin and having an outer surface exposed to an external space, an inner cover portion formed of resin and forming a resin interface where the inner cover portion is in close contact with the outer cover portion, and a metal plate interposed between the outer cover portion and the inner cover portion. The resin interface includes a first edge portion and a second edge portion and is arranged in such a manner that the first edge portion is located on the metal plate and that the second edge portion leads to the internal space.

This nonprovisional application is based on Japanese Patent Application No. 2015-199406 filed on Oct. 7, 2015 with the Japan Patent Office, the entire contents of which are hereby incorporated by reference.

### BACKGROUND OF THE INVENTION

Field of the Invention

The present invention relates generally to an electric compressor and relates more particularly to an inverter-integrated electric compressor.

Description of the Background Art

Regarding a conventional electric compressor, for example, Japanese Patent Laying-Open No. 2012-211533 discloses an electric compressor intended to reliably prevent leakage of electricity from a driving circuit while preventing generation of noises.

The electric compressor disclosed in Japanese Patent Laying-Open No. 2012-211533 includes a compression mechanism that compresses a refrigerant, a motor mechanism that actuates the compression mechanism, a driving circuit (inverter circuit) that drives the motor mechanism, an inner housing accommodating the compression mechanism and the motor mechanism in a sealed state and holds the driving circuit, and an outer housing accommodating the inner housing.

Japanese Patent Laying-Open No. 2013-209909 discloses an inverter-integrated electric compressor intended to prevent vibrations of an inverter cover and to prevent generation of abnormal noises by shifting the resonance point with the natural frequency of a source of vibration and lowering the peak of the resonance point.

The inverter-integrated electric compressor disclosed in Japanese Patent Laying-Open No. 2013-209909 includes an electric motor that drives a compression mechanism, an inverter for driving the electric motor, a center housing accommodating the compression mechanism and the electric motor, and an inverter cover that is connected to the center housing and defines, in conjunction with the center housing, a space accommodating the inverter.

Japanese Patent Laying-Open No. 2013-55298 discloses an electromagnetic-wave shielding cover advantageous for weight saving and intended to have enhanced sealing properties. The electromagnetic-wave shielding cover disclosed in Japanese Patent Laying-Open No. 2013-55298 is arranged to cover, with a gasket, the opening of the casing accommodating electronic components. The electromagnetic-wave shielding cover includes a cover body laminated on a shielding metal plate, and a connector portion that includes electrodes and that is formed integrally with the cover body with a resin composition.

Japanese Patent Laying-Open No. 2006-166604 discloses a power conversion device intended to reduce thermal resistance between a power semiconductor module and a liquid coolant. The power conversion device disclosed in Japanese Patent Laying-Open No. 2006-166604 includes a power semiconductor module having an electrically insulating lower surface exposed as a surface for heat radiation, and a channel cover having an opening that is arranged to cover the lower surface of the power semiconductor module.

### SUMMARY OF THE INVENTION

As disclosed in Japanese Patent Laying-Open Nos. 2012-211533 and 2013-209909, an inverter-integrated electric compressor is known.

In such an electric compressor, a combination of a plurality of resin covers may be used as a cover body (hereinafter also referred to as “inverter cover”) that defines an internal space accommodating an inverter. In this case, sufficient sealing capability needs to be maintained at the resin interface between the resin covers in order to prevent water etc. from entering the internal space accommodating the inverter. Trying to meet such a need, however, may result in decrease in a degree of freedom in design of the inverter covers, such as limitations on choices of materials for the resin covers.

Accordingly, an object of the present invention is to solve the above problem and to provide an electric compressor with an inverter cover having a high degree of freedom in design.

An electric compressor according to the present invention includes a compression mechanism unit that compresses a fluid; an electric motor that drives the compression mechanism unit; a housing accommodating the compression mechanism unit and the electric motor; an inverter that converts direct-current power to alternating-current power and applies the alternating-current power to the electric motor; a cover body attached to the housing and defining, in conjunction with the housing, an internal space accommodating the inverter; and a sealing member disposed between the cover body and the housing and sealing the internal space. The cover body includes a first cover portion formed of resin and having an outer surface exposed to an external space, a second cover portion formed of resin and forming a resin interface where the second cover portion is in close contact with the first cover portion, and a metal plate interposed between the first cover portion and the second cover portion. The resin interface includes a first edge portion and a second edge portion and is arranged in such a manner that the first edge portion is located on the metal plate and that the second edge portion leads to the internal space.

The present invention can provide an electric compressor that has a high degree of freedom in design of an inverter cover.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram showing a general configuration of an electric compressor in an embodiment of the present invention.

FIG. 2 is a partially enlarged cross section of an inverter cover and a housing shown in FIG. 1.

FIG. 3 is a cross section of an area shown in FIG. 2 and surrounded by the double-dotted chain line III.

### DESCRIPTION OF THE PREFERRED EMBODIMENTS

Hereinafter reference will be made to the drawings to describe an embodiment of the present invention. Note that in the figures referred to hereinafter, identical or equivalent members are identically denoted.

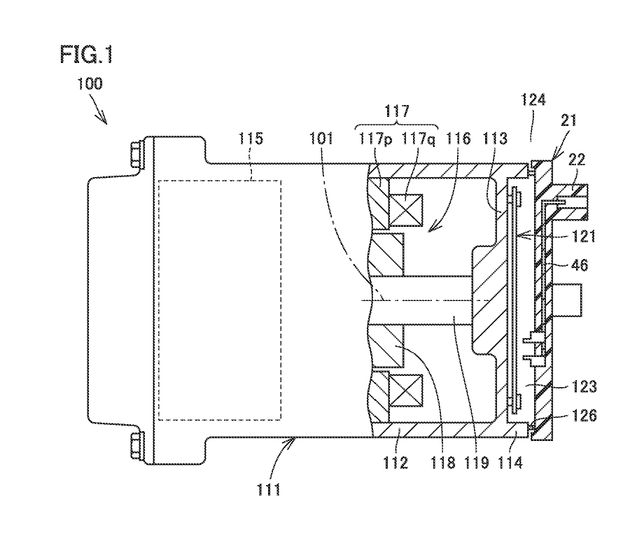

FIG. 1 is a schematic diagram showing a general configuration of an electric compressor in an embodiment of the present invention. With reference to FIG. 1, an electric compressor 100 is an electric compressor mounted on a vehicle and is used to compress a refrigerant for air-conditioning inside the vehicle.

As an example, the electric compressor 100 is mounted on a hybrid vehicle having as a source of power an internal combustion engine such as a gasoline engine and a diesel engine, and a motor driven by electric power supplied from a battery. As another example, the electric compressor 100 is mounted on an electric vehicle or a fuel cell powered vehicle.

The electric compressor 100 is mounted in an engine compartment of a vehicle. The electric compressor 100 is attached to an engine in the engine compartment. The electric compressor 100 may be attached not only to the engine, but also, for example, to a stay provided in the engine compartment. The electric compressor 100 may be attached to a portion of the vehicle other than the engine compartment.

The electric compressor 100 includes a compression mechanism unit 115, an electric motor 116, a housing 111, an inverter 121, an inverter cover 21, a sealing member 126, and a bus bar 46.

The compression mechanism unit 115 is driven to compress the refrigerant. As an example, the compression mechanism unit 115 includes a fixed scroll fixed in the housing 111 and a movable scroll facing the fixed scroll.

The electric motor 116 drives the compression mechanism unit 115. The electric motor 116 includes a rotor 118, a rotary shaft 119, and a stator 117. The rotary shaft 119 extends in the form of a shaft along the central axis 101 which is the center of rotation of the electric motor 116. The rotary shaft 119 is supported in the housing 111 rotatably about the central axis 101. That is, the central axis 101 coincides with the center of rotation of the rotary shaft 119. The rotary shaft 119 has an end connected to the compression mechanism unit 115.

The rotary shaft 119 has an outer circumference with the rotor 118 fixed thereon. The stator 117 includes a stator core 117p and a coil 117q. The stator core 117p is fixed to an inner circumferential surface of the housing 111. The coil 117q is wound around teeth (not shown) of the stator core 117p. The rotor 118 and the stator 117 face each other with a gap lying therebetween in the radial direction of the rotary shaft 119.

The compression mechanism unit 115 and the electric motor 116 are accommodated in the housing 111. The housing 111 is formed of metal such as aluminum. The housing 111 includes a cylindrical portion 112, a bottom portion 113, and a side wall portion 114 as its constituent portions.

The cylindrical portion 112 has a cylindrical shape along the axial direction of the central axis 101. In the cylindrical portion 112 the compression mechanism unit 115 and the electric motor 116 are accommodated. The bottom portion 113 forms the bottom covering one opening of the cylindrical portion 112 in its axial direction. The bottom portion 113 separates off a space that accommodates the compression mechanism unit 115 and the electric motor 116, and an internal space 123 that accommodates the later-described inverter 121, from each other. The side wall portion 114 protrudes from the periphery portion of the bottom portion 113 and forms a wall. The side wall portion 114 protrudes in the direction away from the compression mechanism unit 115 and the electric motor 116 in the axial direction of the central axis 101. The side wall portion 114 has a shape such that it circles around the central axis 101 when seen from the axial direction of the central axis 101.

The inverter cover 21 is attached to the housing 111. The housing 111 and the inverter cover 21 present the appearance of the electric compressor 100.

More specifically, the inverter cover 21 is disposed in such a manner as to face the bottom portion 113 in the axial direction of the central axis 101. The inverter cover 21 is attached to the side wall portion 114 with a sealing member 126 described later. As a whole, the inverter cover 21 has a shape such that it extends in the form of a flat plate in a plane intersecting with the central axis 101 (i.e., disc shape). The inverter cover 21 defines, in conjunction with the housing 111 (the bottom portion 113 and the side wall portion 114), the internal space 123 accommodating the inverter 121.

The inverter cover 21 includes a power input port 22 as its constituent portion. The power input port 22 has a cylindrical shape protruding toward an external space 124. The power input port 22 is connected to an external connector which supplies direct-current power to the inverter 121.

The inverter 121 converts externally supplied direct-current power to alternating-current power and applies the alternating-current power to the electric motor 116. The inverter 121 is typically shown in the drawing as a mere substrate with an inverter circuit formed thereon. The inverter 121, however, also includes electronic components, such as a capacitor, and a variety of lines.

The bus bar 46 is provided integrally with the inverter cover 21. The bus bar 46 is formed of an electrically conductive member. The bus bar 46 is arranged in such a manner as to extend from the inside of the power input port 22 through the inside of the inverter cover 21 to the internal space 123. Making a connection between the power input port 22 and the external connector allows direct-current power to be supplied to the inverter 121 via the bus bar 46.

The sealing member 126 is disposed between the inverter cover 21 and the housing 111. The sealing member 126 has a shape such that it annularly extends corresponding to the side wall portion 114 when seen from the axial direction of the central axis 101. The sealing member 126 is disposed in contact with the side wall portion 114 of the housing 111. The sealing member 126 seals the internal space 123. That is, the space inside the annular sealing member 126 is the internal space 123, and the space outside the annular sealing member 126 is the external space 124.

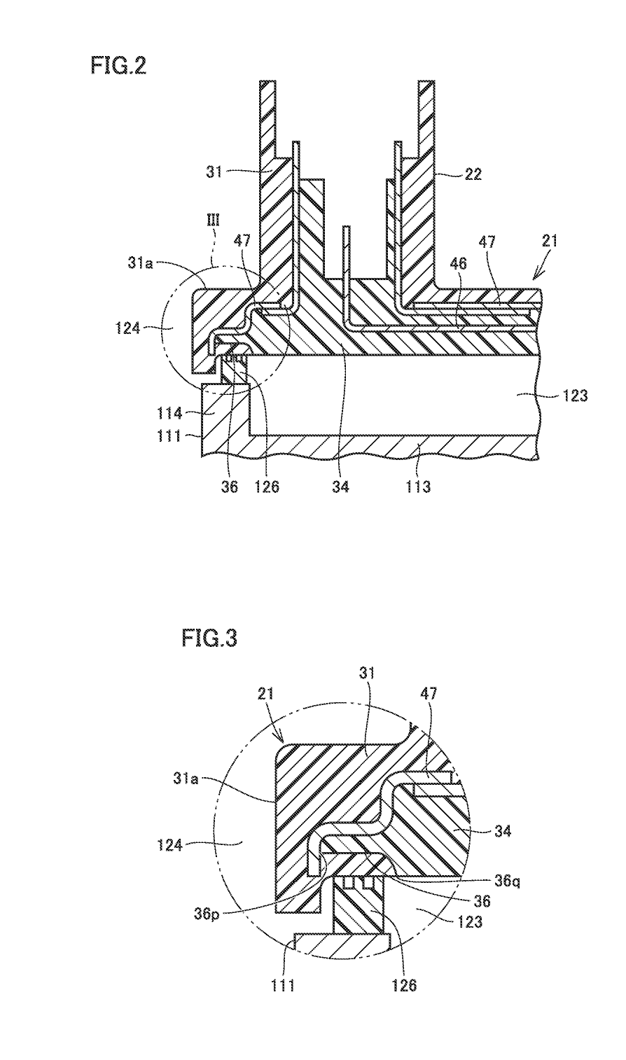

FIG. 2 is a partially enlarged cross section of the inverter cover and the housing shown in FIG. 1. FIG. 3 is a cross section of a range shown in FIG. 2 and surrounded by the double-dotted chain line III. The structure of the inverter cover 21 will be described in more detail with reference to FIGS. 1 to 3.

The inverter cover 21 includes an outer cover portion 31, an inner cover portion 34, and a metal plate 47. The outer cover portion 31, the inner cover portion 34, and the metal plate 47 each have a disc shape as a whole and are superposed on top of one another in the axial direction of the central axis 101. The outer cover portion 31 and the inner cover portion 34 are each formed of resin. The metal plate 47 is formed of metal.

The metal plate 47 is interposed between the outer cover portion 31 and the inner cover portion 34. The metal plate 47 is arranged so as to cover the inverter 121 when seen from the axial direction of the central axis 101. The metal plate 47 is provided as a shielding material against noises generated in the inverter 121.

The outer cover portion 31 is superposed on the metal plate 47 from the external space 124 side. The outer cover portion 31 has an outer surface 31a. The outer surface 31a is exposed to the external space 124. The outer surface 31a of the inverter cover 21 presents the appearance of the electric compressor 100. The sealing member 126 is disposed in contact with the outer cover portion 31 of the inverter cover 21.

The inner cover portion 34 is superposed on the metal plate 47 from the internal space 123 side. The inner cover portion 34 defines the internal space 123 at a position facing the bottom portion 113 of the housing 111. The bus bar 46 is embedded in the inner cover portion 34 of the inverter cover 21. The bus bar 46 is formed through insert molding in the inner cover portion 34.

The outer cover portion 31 and the inner cover portion 34 are formed of different types of resins. In the present embodiment, the resin forming the inner cover portion 34 has higher electrical insulation properties than the resin forming the outer cover portion 31. Such a configuration can ensure sufficient electrical insulation properties between the bus bar 46 and the metal plate 47.

Further, in the present embodiment, the resin forming the outer cover portion 31 has a higher tensile strength than the resin forming the inner cover portion 34. Such a configuration can effectively prevent deformation and breakage of the inverter cover 21 when an excessive force is externally exerted on the inverter cover 21.

Examples of the resin forming the outer cover portion 31 include polyamide resin (PA material), and examples of the resin forming the inner cover portion 34 include polybutylene terephthalate (PBT material).

The outer cover portion 31 and the inner cover portion 34 form the resin interface 36. The resin interface 36 is formed with the outer cover portion 31 and the inner cover portion 34 in close contact with each other with no metal plate 47 lying therebetween. That is, a surface that is in close contact with the outer cover portion 31 in the inner cover portion 34 is the resin interface 36, and therefore the inner cover portion 34 forms the resin interface 36. In the present embodiment, the boundary between the outer cover portion 31 and the inner cover portion 34 is composed of a part where the metal plate 47 is interposed and of the resin interface 36 where the different types of resins are in close contact with each other.

The resin interface 36 includes a first edge portion 36p and a second edge portion 36q. The resin interface 36 is arranged in such a manner that the first edge portion 36p is located on the metal plate 47 and that the second edge portion 36q leads to the internal space 123.

More specifically, the resin interface 36 has a shape such that it circles around the central axis 101 in the form of a belt when seen from the axial direction of the central axis 101. In a cross section of the inverter cover 21 taken along a plane including the central axis 101 (i.e., in the cross sections shown in FIGS. 2 and 3), the first edge portion 36p of the resin interface 36 is located on the metal plate 47 and the second edge portion 36q of the resin interface 36 leads to the internal space 123.

In the present embodiment, the first edge portion 36p is disposed on the outer side relative to the second edge portion 36q in the radial direction with respect to the rotational axis of the electric motor 116 in the cross section of the resin interface 36. That is, the first edge portion 36p is an outer circumferential edge portion of the resin interface 36. The first edge portion 36p is located on a surface of the metal plate 47. The first edge portion 36p is disposed on the outer circumferential side relative to the sealing member 126, immediately above the side wall portion 114 of the housing 111 in the axial direction of the central axis 101.

The second edge portion 36q is disposed on the inner circumferential side around the central axis 101 in the cross section of the resin interface 36. That is, the second edge portion 36q is an inner circumferential edge portion of the resin interface 36. The second edge portion 36q is disposed on the inner circumferential side relative to the sealing member 126. The resin interface 36 includes the first edge portion 36p, a first surface that extends from the first edge portion 36p radially inward with respect to the central axis 101, a second surface that extends in the axial direction of the central axis 101 from the first surface to the second edge portion 36q, and the second edge portion 36q.

Since weldability between different types of resins is not good, it is generally difficult to ensure sealing capability at a resin interface where the resins are in close contact with each other. In contrast to this, in the present embodiment, the first edge portion 36p of the resin interface 36 is located on the metal plate 47 and the second edge portion 36q of the resin interface 36 leads to the internal space 123, whereby the resin interface 36 does not act as a pathway of entry of water etc. from the external space 124 to the internal space 123. This eliminates the need for consideration of sealing capability at the resin interface 36 and thus allows different types of resins to be chosen as the resins forming the outer cover portion 31 and the inner cover portion 34.

The choices of resins forming the outer cover portion 31 and the inner cover portion 34 are not limited to those described in the present embodiment. For example, environment resistance, weather resistance, and chemical resistance etc. may be considered as the properties of the resin forming the outer cover portion 31 since the outer cover portion 31 is exposed to the external space 124. In the present embodiment, the resin forming the outer cover portion 31 needs to have such properties since the electric compressor 100 is attached in the engine compartment of a vehicle.

Further, the resin forming the outer cover portion 31 and the resin forming the inner cover portion 34 may be of the same type. In this case, it is not necessary to manage the weldability between the outer cover portion 31 and the inner cover portion 34.

The structure of the electric compressor according to the embodiment of the present invention described above is summarized as follows: the electric compressor 100 in the present embodiment includes the compression mechanism unit 115 that compresses a refrigerant as a fluid; the electric motor 116 that drives the compression mechanism unit 115; the housing 111 accommodating the compression mechanism unit 115 and the electric motor 116; the inverter 121 that converts direct-current power to alternating-current power and applies the alternating-current power to the electric motor 116; the inverter cover 21 as a cover body attached to the housing 111 and defining, in conjunction with the housing 111, the internal space 123 accommodating the inverter 121; and the sealing member 126 disposed between the inverter cover 21 and the housing 111 and sealing the internal space 123.

The inverter cover 21 includes the outer cover portion 31 as a first cover portion formed of resin and having the outer surface 31a exposed to the external space 124, the inner cover portion 34 as a second cover portion formed of resin and forming the resin interface 36 where the inner cover portion 34 is in close contact with the outer cover portion 31, and the metal plate 47 interposed between the outer cover portion 31 and the inner cover portion 34. The resin interface 36 includes the first edge portion 36p and the second edge portion 36q and is arranged in such a manner that the first edge portion 36p is located on the metal plate 47 and that the second edge portion 36q leads to the internal space 123.

According to the electric compressor 100 of the embodiment of the present invention thus configured, the inverter cover 21 has an enhanced degree of freedom in design. Thus, a high-quality inverter cover 21 that can deliver desired performance can be provided.

Note that while in the present embodiment, the electric compressor 100 has been described as an in-line electric compressor where the compression mechanism unit 115, the electric motor 116, and the inverter 121 are linearly arranged, the present invention is not limited to such a configuration. The present invention may also be applied to a camel electric compressor where the inverter 121 is provided in the cylindrical portion 112 of the housing 111.

An electric compressor according to the present invention includes a compression mechanism unit that compresses a fluid; an electric motor that drives the compression mechanism unit; a housing accommodating the compression mechanism unit and the electric motor; an inverter that converts direct-current power to alternating-current power and applies the alternating-current power to the electric motor; a cover body attached to the housing and defining, in conjunction with the housing, an internal space accommodating the inverter; and a sealing member disposed between the cover body and the housing and sealing the internal space. The cover body includes a first cover portion formed of resin and having an outer surface exposed to an external space, a second cover portion formed of resin and forming a resin interface where the second cover portion is in close contact with the first cover portion, and a metal plate interposed between the first cover portion and the second cover portion. The resin interface includes a first edge portion and a second edge portion and is arranged in such a manner that the first edge portion is located on the metal plate and that the second edge portion leads to the internal space.

According to the electric compressor thus configured, the first edge portion of the resin interface is located on the metal plate and the second edge portion of the resin interface leads to the internal space. Accordingly, the resin interface does not act as a pathway of entry of water etc. from the external space to the internal space. This eliminates the need for maintaining sealing capability at the resin interface and thus enhances a degree of freedom in design of the cover body.

Furthermore, preferably, the first cover portion and the second cover portion are formed of different types of resins.

According to the electric compressor thus configured, the first cover portion and the second cover portion are allowed to have properties different from each other and whereby a cover body that delivers desired performance can be obtained.

Furthermore, preferably, the electric compressor further includes a bus bar provided integrally with the second cover portion and connected to the inverter. The resin forming the second cover portion has higher electrical insulation properties than the resin forming the first cover portion.

The electric compressor thus configured can ensure high electrical insulation properties against the bus bar provided integrally with the second cover portion.

Furthermore, preferably, the first cover portion and the second cover portion are formed of resin identical in type.

According to the electric compressor thus configured, it is not necessary to manage the weldability of the resin between the first cover portion and the second cover portion.

The present invention is mainly applied to an inverter-integrated electric compressor.

Though the embodiment of the present invention has been described, it should be understood that the embodiment disclosed herein is for the purpose of illustration only and non-restrictive in any respect. The scope of the present invention is defined by the terms of the claims and is intended to include any modifications within the meaning and scope equivalent to the terms of the claims.

What is claimed is:

1. An electric compressor comprising:
a compression mechanism unit that compresses a fluid;
an electric motor that drives the compression mechanism unit;
a housing accommodating the compression mechanism unit and the electric motor;
an inverter that converts direct-current power to alternating-current power and applies the alternating-current power to the electric motor;
a cover body attached to the housing and defining, in conjunction with the housing, an internal space accommodating the inverter; and
a sealing member disposed between the cover body and the housing and sealing the internal space,
the cover body including
a first cover portion formed of resin and having an outer surface exposed to an external space,
a second cover portion formed of resin and forming a resin interface where the second cover portion is in close contact with the first cover portion, and
a metal plate interposed between the first cover portion and the second cover portion, and
the resin interface including a first edge portion and a second edge portion and being arranged in such a manner that the first edge portion is located on the metal plate and that the second edge portion leads to the internal space.

2. The electric compressor according to claim 1, wherein the first cover portion and the second cover portion are formed of different types of resins.

3. The electric compressor according to claim 2, further comprising a bus bar provided integrally with the second cover portion and connected to the inverter, wherein the resin forming the second cover portion has higher electrical insulation properties than the resin forming the first cover portion.

4. The electric compressor according to claim 1, wherein the first cover portion and the second cover portion are formed of resin identical in type.
